(19) United States
(12) Patent Application Publication
(10) Pub. No.: US 2021/0009822 A1
(43) Pub. Date: Jan. 14, 2021

(54) INK, INK ACCOMMODATING CONTAINER, RECORDING DEVICE, AND RECORDING METHOD

(71) Applicants: Kento SUGITA, Tokyo (JP); Dongsik JANG, Tokyo (JP); Yukihiro IMANAGA, Kanagawa (JP)

(72) Inventors: Kento SUGITA, Tokyo (JP); Dongsik JANG, Tokyo (JP); Yukihiro IMANAGA, Kanagawa (JP)

(21) Appl. No.: 16/910,745

(22) Filed: Jun. 24, 2020

(30) Foreign Application Priority Data
Jul. 11, 2019 (JP) 2019-129252

(51) Int. Cl. C09D 11/037; C08L 75/04; C08L 25/14; C09D 11/102

(52) U.S. Cl. CPC C09D 11/037; C09D 11/102; C08L 25/14; C08L 75/04

(57) ABSTRACT

An ink contains a pigment, a urethane resin, and a styrene acrylic resin, wherein dry film of the ink has a breaking stress of 4.7 or greater N/mm².

### CROSS-REFERENCE TO RELATED APPLICATIONS

This patent application is based on and claims priority pursuant to 35 U.S.C. § 119 to Japanese Patent Application No. 2019-129252, filed on Jul. 11, 2019, in the Japan Patent Office, the entire disclosure of which is hereby incorporated by reference herein.

### BACKGROUND

### Technical Field

The present invention relates to an ink, an ink accommodating container, a recording device, and a recording method.

### Description of the Related Art

In inkjet recording, a small amount of ink droplets are discharged from fine nozzles and attached to a recording medium, typically paper, to create text and images thereon. Inkjet printers performing the inkjet recording method are relatively quiet and capable of printing color images with ease, so they are now widely used at home. The inkjet recording method is also used in commercial and industrial settings because it is suitable for high performance printing.

Ink used in such settings are accordingly required to enhance image quality, color hue, color saturation, gloss, friction resistance, marker resistance, and other properties. In particular, friction resistance should be enhanced.

One way to enhance friction resistance of images formed with ink is to add a resin to the ink.

### SUMMARY

According to embodiments of the present disclosure, an ink is provided which contains a pigment, a urethane resin, and a styrene acrylic resin, wherein dry film of the ink has a breaking stress of 4.7 or greater N/mm².

### BRIEF DESCRIPTION OF THE SEVERAL VIEWS OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic diagram illustrating an example of a recording device;

FIG. 2 is a schematic diagram illustrating an example of a jig for evaluating friction resistance; and

FIG. 3 is a schematic diagram illustrating an example of a plate.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

Moreover, image forming, recording, printing, modeling, etc., in the present disclosure represent the same meaning, unless otherwise specified.

Embodiments of the present invention are described in detail below with reference to accompanying drawing(s). In describing embodiments illustrated in the drawing(s), specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

Ink for such application achieving higher image quality, color hue, color saturation, gloss, friction resistance, marker resistance, and other properties is needed accordingly. In particular, friction resistance should be enhanced. An example of enhancing friction resistance of images formed with ink includes a method of adding a resin in the ink.

An inkjet ink containing a polyurethane resin and carbon black dispersed with a copolymer of styrene-acrylic acid has been disclosed in JP 2012-214712-A1.

Images printed in gray scale using such a resin containing ink, however, problematically suffer image peeling in intermediate gray scale regions.

The ink of the present disclosure provides an ink that reduces image defects in a intermediate gray scale region when images are printed by gray scale printing.

Next, aspects of embodiments of the present disclosure are described.

Ink

The ink of the present embodiment contains a pigment and a resin and other optional substances such as an organic solvent, water, and a surfactant. The resin contains a urethane resin and a styrene acrylic resin and other optional resins.

The ink of the present embodiment was formulated based on the knowledge that just adding known materials to ink does not enhance friction resistance in some cases.

Here “some cases” is not limited and includes high performance printing on a poorly permeating recording medium ink minimally permeated by gray-scale printing.

Since the ink does not readily permeate to the inside of the poorly permeating recording medium during high performance printing, most of the ink remains on the surface of the recording medium. Also, the recording medium is quickly reeled after printing, during which printed images are readily frictioned.

This results in image defects. Accordingly, the level of friction resistance required for images printed with ink is high.

Another case involves gray scale printing.

Regions printed in intermediate gray scale are readily abraded because dots are spaced unlike in solid image portions where multiple merged dots form a film.

For this reason, the region may suffer image defects. The level of friction resistance required for images printed with ink is accordingly high.

To address this issue, controlling breaking stress, which is a mechanical property of images, is required.

The breaking stress of a dried ink film should be 4.7 N/mm² or greater and preferably from 4.7 to 6.0 N/mm² at 23.5 degrees C.

When the breaking stress is 4.7 N/mm² or greater, images formed with the ink are more durable, which leads to good friction resistance.

A dried film for measuring breaking stress measuring is prepared by placing 8.0 g of ink in a Teflon® petri dish having a diameter of 5 cm, allowing it to stand in a thermostatic chamber at 40 degrees C. for 12 hours, drying the ink in the chamber at 120 degrees C. for four hours, and cutting the dried ink into a size of 10 mm×5 mm.

Breaking stress is measured under conditions such as the following or others that are based on this measuring principle.

Measuring Conditions
Measuring device: Desktop precision universal tester (Autograph AGS-5kNX, manufactured by Shimadzu Corporation)
Test mode: Single
Test type: Tensile
Load cell capacity: 50 N
Control operation: Load
Control: stroke
Test speed: 50 mm/minute
Test piece form: flat plate-like form
Number of batches: 1
Number of sub-batches: 1

The method of adjusting the breaking stress to the above-specified range is not particularly limited. For example, using urethane or styrene-acrylic resin particles as the resin described later and small urethane resin particles are usable. Small urethane resin particles fill the gap between pigments having larger particle diameters than those of the small urethane resin particles and styrene acrylic resin particles and thereby enhances attachability between each particle, which increases the breaking stress of a dry film. The friction resistance is enhanced as a result. When the glass transition temperature Tg of urethane resin particles is −10 or lower degrees C., attachability between particles of pigments and styrene acrylic resins is enhanced so that bearing stress of dry film increases. The friction resistance is enhanced as a result.

When the mass ratio of urethane resins to pigments in ink is 0.55 or greater, the dry film has a high breaking stress and friction resistance is enhanced as a result.

When ink a dry film of which has a high breaking stress is used for high performance printing on a low permeable recording medium the ink does not readily permeate, the printed images have excellent friction resistance.

Resin

The ink of the present embodiment contains a resin. The resin contains a urethane resin, a styrene-acrylic resin, and other optional resins. Specific examples of the other optional resins include, but are not limited to, polyester resins, acrylic resins, vinyl acetate resins, styrene resins, butadiene resins, styrene-butadiene resins, vinyl chloride resins, and acrylic silicone resins.

Urethane Resin

The ink of the present embodiment contains a urethane resin. Because urethane resins have excellent elasticity when they dry, they have more excellent fixability than other resins, which is preferable. Fixability of an image formed with ink containing a urethane resin to a recording medium is enhanced by adjusting the breaking stress to the above-mentioned range when the ink is applied to the recording medium being conveyed at high speed. For this reason, the image is prevented from peeling off from the region represented in intermediate gray scale when printed by gray scale printing. “Being conveyed at high speed” means conveyance speed of 0.8 or greater m/s. “the region represented in intermediate gray scale when printed by gray scale printing” has an ink dot area ratio of from 40 to 90 percent in the printing area in the printing range of the gray scale printing.

It is possible to synthesize or commercially procure a urethane resin. Specific examples of procurable urethane resins include, but are not limited to, SUPERFLEX® 420, SUPERFLEX® 420NS, SUPERFLEX® 460, SUPERFLEX® 460S, SUPERFLEX® 470, SUPERFLEX® 500M, SUPERFLEX® 650, and SUPERFLEX® 740 (all manufactured by DKS Co., Ltd.), and TAKELAC™ W6110 (manufactured by Mitsui Chemicals MC Co., Ltd.).

The glass transition temperature Tg of the urethane resin is preferably from −10 or lower degrees C. and more preferably from −30 to −10 degrees C. When the glass transition temperature Tg is −10 or lower degrees, attachability between a pigment, a styrene acrylic resin particle, and a recording medium is enhanced and friction resistance is thereby enhanced. This temperature range makes it easy to control the breaking stress of a dry film in the range mentioned above.

The urethane resin is preferably a resin emulsion. The resin emulsion refers to a state in which resin particles are dispersed in an aqueous medium such as water and ink. It does not matter whether the resin particle is solid or liquid. The aqueous medium includes a substance containing water or a hydrophilic solvent as a component.

Examples of a method of dispersing resin particles in water or an aqueous medium such as ink include, but are not limited to, a forced emulsification method using a dispersant and a self-emulsification method using a resin having an anionic group. A dispersant may remain in an image formed with ink in the forced emulsification method, thereby degrading the strength of the image. Therefore, using the self-emulsification method is preferable.

It is preferable to use urethane resin particles having a 50 percent cumulative volume particle diameter (D50) of from 10 to 30 nm. Small urethane resin particles having a particle diameter of from 10 to 30 nm fill the gap between a pigment, styrene acrylic resin particles, and a recording medium and thereby enhances attachability therebetween, which improves friction resistance. This temperature range makes it easy to control the breaking stress of a dry film in the range mentioned above. The 50 percent cumulative volume particle diameter (D50) represents a particle diameter at which the volume distribution frequency is 50 percent and is measured by a particle size analyzer (Nanotrac Wave-UT151, manufactured by MicrotracBEL Corp.) or other instruments.

It is preferable that when a urethan resin and a styrene acrylic resin be contained in ink in a form of resin particle, the 50 percent cumulative volume particle diameter (D50) of the urethane resin be smaller than that of the styrene acrylic resin, which is described later.

The proportion of the urethane resin is not particularly limited and can be suitably selected to suit to a particular application. For example, it is preferably from 1.0 to 20.0 percent by mass, more preferably from 1.0 to 10.0 percent by mass, and furthermore preferably from 2.0 to 6.0 percent by mass in the total amount of ink to enhance friction resistance and storage stability and discharging stability of ink.

The mass ratio of the urethane resin to the pigment in the ink is preferably 0.55 or greater and more preferably from 0.55 to 1.50. When the mass ratio is 0.55 or greater, image peeling or image defects at regions represented in intermediate gray scale is prevented when images are printed by gray scale printing. It is prevented even when the conveyance speed of a recording medium is high, for example, 0.8 or greater m/s or a low permeable recording medium is used. This temperature range makes it easy to control the breaking stress of a dry film in the range mentioned above.

Styrene-Acrylic Resin

The ink of the present embodiment contains a styrene acrylic resin. The styrene acrylic resin melts and forms a film during drying of ink, which enhances friction resistance of an image formed with the ink. Fixability of an image formed with ink to a recording medium is enhanced by the ink containing a styrene acrylic resin and adjusting the breaking stress to the above-mentioned range when the ink is applied to the recording medium being conveyed at high speed. For this reason, the image is prevented from peeling off from the region represented in intermediate gray scale when printed by gray scale printing.

It is possible to synthesize or commercially procure a styrene-acrylic resin. Specific examples of the procurable styrene acrylic resin includes, but are not limited to, KE-1062, VS-1063, and YS-1274 (all manufactured by SEIKO PMC CORPORATION), FS-201 (manufactured by Nipponpaint Industrial Coatings Co., LTD.), 7QX-095 (manufactured by TAISEI FINE CHEMICAL CO., LTD.), ACRYCOTE AF-2006, ACRYCOTE AF-7800, ACRYCOTE AF-7802, ACRYCOTE AF-362, ACRYCOTE AP-1010M, ACRYCOTE AP-2352, and ACRYCOTE AP-1354 (manufactured by Advanced Polymer Emulsions Company).

The glass transition temperature Tg of the styrene acrylic resin is preferably 60 to 120 degrees C. and more preferably from 70 to 110 degrees C. The glass transition temperature Tg being from 60 to 120 degrees C. enhances image density.

The styrene acrylic resin is preferably a resin emulsion. The resin emulsion refers to a state in which resin particles are dispersed in an aqueous medium such as water and ink. It does not matter whether the resin particle is solid or liquid. The aqueous medium includes a substance containing water or a hydrophilic solvent as a component.

Examples of a method of dispersing resin particles in water or an aqueous medium such as ink include, but are not limited to, a forced emulsification method using a dispersant and a self-emulsification method using a resin having an anionic group. A dispersant may remain in an image formed with the ink, thereby degrading the strength of the image in the forced emulsification method. Therefore, using the self-emulsification method is preferable.

When styrene acrylic resins are used in a form of resin particles, 50 percent cumulative volume particle diameter (D50) of the resin particle is preferably from 40 to 150 nm and more preferably from 50 to 140 nm. Styrene acrylic resins of from 40 to 150 nm readily melt and form films during drying ink. The friction resistance of an image formed with ink is further enhanced as a result. 50 percent cumulative volume particle diameter (D50) represents a particle diameter at which the volume distribution frequency is 50 percent and is measured by a particle size analyzer (Nanotrac Wave-UT151, manufactured by MicrotracBEL Corp.) or other instruments.

The proportion of the styrene acrylic resin is not particularly limited and can be suitably selected to suit to a particular application. For example, it is preferably from 1.0 to 20.0 percent by mass, more preferably from 1.0 to 10.0 percent by mass, and furthermore preferably from 2.0 to 6.0 percent by mass in the total amount of ink to enhance friction resistance and storage stability and discharging stability of ink.

The mass ratio of the styrene acrylic resin to the pigment in the ink is preferably from 0.5 to 1.5 and more preferably from 0.6 to 1.2. When the mass ratio is from 0.5 to1.5, image peeling or image defects at regions represented in intermediate gray scale is prevented when images are printed by gray scale printing. It is prevented even when the conveyance speed of a recording medium is high, for example, 0.8 or greater m/s or a low permeable recording medium is used. This temperature range makes it easy to control the breaking stress of a dry film in the range mentioned above.

The mass ratio of the styrene acrylic resin to the urethane resin in the ink is preferably from 0.5 to 2.0 and more preferably from 0.8 to 1.5. When the mass ratio is from 0.5 to 2.0, it is possible to reduce image peeling or image defects of images at regions represented in intermediate gray scale which have been printed by gray scale printing. It is also possible to reduce the image peeling or image defects even when the conveyance speed of a recording medium is high, for example, 0.8 or greater m/s or a low permeable recording medium is used. This temperature range makes it easy to control the breaking stress of a dry film in the range mentioned above.

Pigment

As the pigment, both inorganic pigments and organic pigments can be used. These can be used alone or in combination. In addition, it is possible to use a mixed crystal. As the pigments, for example, black pigments, yellow pigments, magenta pigments, cyan pigments, white pigments, green pigments, orange pigments, and gloss or metallic pigments of gold, silver, and others can be used. As the inorganic pigments, in addition to titanium oxide, iron oxide, calcium carbonate, barium sulfate, aluminum hydroxide, barium yellow, cadmium red, and chrome yellow, carbon black manufactured by known methods such as contact methods, furnace methods, and thermal methods can be used. As the organic pigments, it is possible to use azo pigments, polycyclic pigments (e.g., phthalocyanine pigments, perylene pigments, perinone pigments, anthraquinone pigments, quinacridone pigments, dioxazine pigments, indigo pigments, thioindigo pigments, isoindolinone pigments, and quinophthalone pigments), dye chelates (e.g., basic dye type chelates and acid dye type chelates), nitro pigments, nitroso pigments, and aniline black can be used. Also, hollow resin particles and hollow inorganic particles can be used.

Specific examples of the pigments for black include, but are not limited to, carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1).

Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51, C.I. Pigment Red 1, 2, 3, 5, 17, 22, 23, 31, 38, 48:2, 48:2 {Permanent Red 2B(Ca)}, 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4, (Phthalocyanine Blue), 16, 17:1, 56, 60, and 63, C.I. Pigment Green 1, 4, 7, 8, 10, 17, 18, and 36.

Poor friction resistance or image defects readily leads to image peeling in a region represented in intermediate gray scale when printed by gray scale printing, which is particularly significant when carbon black is used. The ink formulation of the present embodiment is particularly effective when carbon black is contained as a pigment.

There are a method of introducing a hydrophilic functional group into a pigment to prepare a self-dispersible pigment, a method of coating the surface of a pigment with a resin, or a method of using a dispersant to disperse a pigment in ink.

As the method of introducing a hydrophilic functional group into a pigment to prepare a self-dispersible pigment, it is possible to add a functional group such as sulfone group and carboxyl group to a pigment to disperse the pigment in water.

As the method of coating the surface of a pigment with a resin, for example, a pigment encapsulated into a microcapsule is used to disperse a pigment in water. This can be referred to as a resin-coated pigment. In this case, all the pigments to be added to the ink are not necessarily entirely coated with a resin. Pigments not or partially coated with a resin may be dispersed in the ink.

When a dispersant is used, a known dispersant having a small or large molecular weight represented by a surfactant is used. It is possible to use surfactants such as an anionic surfactant, a cationic surfactant, a nonionic surfactant, and an amphoteric surfactant depending on a pigment. Also, a nonionic surfactant (RT-100, manufactured by TAKEMOTO OIL & FAT CO., LTD.) and a formalin condensate of naphthalene sodium sulfonate are suitable as the dispersant. Those can be used alone or in combination.

The proportion of the pigment in the ink is preferably from 1.0 to 10.0 percent by mass and more preferably from 4.0 to 8.0 percent by mass. It is possible to reduce image peeling in a region represented in intermediate gray scale when images are printed by gray scale printing if the proportion is within the range mentioned above.

The sum of the proportion of the pigment, urethane resin, and styrene acrylic resin in the total amount of the ink is preferably from 10.0 to 20.0 percent by mass and more preferably from 15.0 to 17.0 percent by mass. When the sum is from 10.0 to 20.0 percent by mass, it is possible to reduce peeling of images in a region represented in intermediate gray scale which have been printed by gray scale printing.

50 percent cumulative volume particle diameter (D50) of the pigment in the ink is preferably from 90 to 120 nm. 50 percent cumulative volume particle diameter (D50) represents a particle diameter at which the volume distribution frequency is 50 percent and is measured by a particle size analyzer (Nanotrac Wave-UT151, manufactured by MicrotracBEL Corp.) or other instruments.

It is possible to mix a pigment with water and a dispersant to prepare a pigment dispersion followed by mixing with a material such as water and an organic solvent for manufacturing ink.

Organic Solvent

The organic solvent is not particularly limited and water-soluble organic solvents can be used. Examples include, but are not limited to, polyols, ethers such as polyol alkyl ethers and polyol arylethers, nitrogen-containing heterocyclic compounds, amides, amines, and sulfur-containing compounds.

Specific examples of the water-soluble organic solvent include, but are not limited to: polyhydric alcohols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, triethylene glycol, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyol aryl ethers such as ethylene glycol monophenyl ether and ethylene glycol monobenzyl ether; nitrogen-containing heterocyclic compounds such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone; amides such as formamide, N-methylformamide, N,N-dimethylformamide, 3-methoxy-N,N-dimethyl propioneamide, and 3-buthoxy-N,N-dimethyl propioneamide; amines such as monoethanolamine, diethanolamine, and triethylamine; sulfur-containing compounds such as dimethyl sulfoxide, sulfolane, and thiodiethanol; propylene carbonate, and ethylene carbonate. It is preferable to use an organic solvent having a boiling point of 250 degrees C. or lower to serve as a humectant and impart a good drying property.

Polyol compounds having eight or more carbon atoms and glycol ether compounds are also suitable. Specific examples of the polyol compounds having eight or more carbon atoms include, but are not limited to, 2-ethyl-1,3-hexanediol and 2,2,4-trimethyl-1,3-pentanediol. Specific examples of the glycolether compounds include, but are not limited to, polyol alkylethers such as ethyleneglycol monoethylether, ethyleneglycol monobutylether, diethyleneglycol monomethylether, diethyleneglycol monoethylether, diethyleneglycol monobutylether, tetraethyleneglycol monomethylether, and propyleneglycol monoethylether; and polyol arylethers such as ethyleneglycol monophenylether and ethyleneglycol monobenzylether.

The polyhydric alcohol compounds having eight or more carbon atoms and glycolether compounds enhance permeability of ink for paper used as a recording medium.

The proportion of the organic solvent of the ink has no particular limit and can be suitably selected to suit to a particular application.

In terms of drying property and discharging reliability of ink, the proportion is preferably from 10 to 60 percent by mass and more preferably from 20 to 60 percent by mass.

Water

The proportion of water in the ink is not particularly limited and can be suitably selected to suit to a particular application. In terms of the drying and discharging reliability of the ink, the proportion is preferably from 10 to 90 percent by mass and more preferably from 20 to 60 percent by mass of the total amount of the ink.

Surfactant

Examples of the surfactant include, but are not limited to, silicone-based surfactants, fluorochemical surfactants, amphoteric surfactants, nonionic surfactants, and anionic surfactants.

The silicone-based surfactant has no specific limit and can be suitably selected to suit to a particular application. In particular, silicone-based surfactants which do not decompose even at a high pH are preferable. Specific examples of the silicone-based surfactant include, but are not limited to, side-chain modified polydimethyl siloxane, both-terminal modified polydimethyl siloxane, one-terminal-modified polydimethyl siloxane, and side chain both-terminal modified polydimethyl siloxane. Silicone-based surfactants having a polyoxyethylene group or polyoxyethylene polyoxypropylene group as the modification group are particularly preferable because these demonstrate good properties as aqueous surfactants. It is possible to use a polyether-modified silicone-based surfactant as the silicone-based surfactant. A specific example is a compound in which a polyalkylene oxide structure is introduced into the side chain of the Si site of dimethyl silooxane.

Specific examples of the fluorochemical surfactant include, but are not limited to, perfluoroalkyl sulfonic acid compounds, perfluoroalkyl carboxylic acid compounds, ester compounds of perfluoroalkyl phosphoric acid, adducts of perfluoroalkyl ethylene oxide, and polyoxyalkylene ether polymer compounds having a perfluoroalkyl ether group in its side chain. These are particularly preferable because the fluorochemical surfactant does not readily produce foams. Specific examples of the perfluoroalkyl sulfonic acid compounds include, but are not limited to, perfluoroalkyl sulfonic acid and salts of perfluoroalkyl sulfonic acid. Specific examples of the perfluoroalkyl carbonic acid compounds include, but are not limited to, perfluoroalkyl carbonic acid and salts of perfluoroalkyl carbonic acid.

Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain, and salts of polyoxyalkylene ether polymers having a perfluoroalkyl ether group in its side chain. Counter ions of salts in these fluorochemical surfactants are, for example, Li, Na, K, NH₄, NH₃CH₂CH₂OH, NH₂(CH₂CH₂OH)₂, and NH(CH₂CH₂OH)₃.

Specific examples of the ampholytic surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides.

Specific examples of the anionic surfactants include, but are not limited to, polyoxyethylene alkyl ether acetates, dodecyl benzene sulfonates, laurates, and polyoxyethylene alkyl ether sulfates.

These can be used alone or in combination.

The silicone-based surfactant has no particular limit and can be suitably selected to suit to a particular application.

Specific examples include, but are not limited to, side-chain-modified polydimethyl siloxane, both distal-end-modified polydimethyl siloxane, one-distal-end-modified polydimethyl siloxane, and side-chain-both-distal-end-modified polydimethyl siloxane.

In particular, a polyether-modified silicone-based surfactant having a polyoxyethylene group or a polyoxyethylene polyoxypropylene group is particularly preferable because such a surfactant demonstrates good property as an aqueous surfactant.

Such surfactants can be synthesized or commercially procured. Products available on the market can be obtained from BYK-Chemie GmbH, Shin-Etsu Silicone Co., Ltd., Dow Corning Toray Co., Ltd., etc., NIHON EMULSION Co., Ltd., Kyoeisha Chemical Co., Ltd., and others.

The polyether-modified silicon-based surfactant has no particular limit and can be suitably selected to suit to a particular application. For example, a compound is usable in which the polyalkylene oxide structure represented by the following Chemical formula S-1 is introduced into the side chain of the Si site of dimethyl polysiloxane.

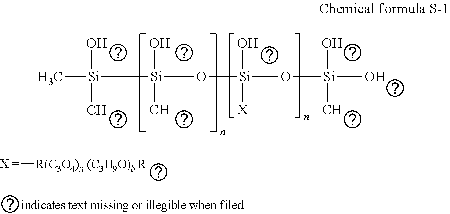

In the Chemical formula S-1, “m”, “n”, “a”, and “b” each, respectively independently represent integers, R represents an alkylene group, and R′represents an alkyl group.

Specific examples of the polyether-modified silicone-based surfactant include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.), FZ-2105, FZ-2118, FZ-2154, FZ-2161, FZ-2162, FZ-2163, and FZ-2164 (all manufactured by Dow Corning Toray Co., Ltd.), BYK-33 and BYK-387 (both manufactured by BYK Chemie GmbH), and TSF4440, TSF4452, and TSF4453 (all manufactured by Momentive Performance Materials Inc.).

A compound in which the number of carbon atoms replaced with fluorine atoms is from 2 to 16 is preferable and, from 4 to 16, more preferable, as the fluorochemical surfactant.

Specific examples of the fluorochemical surfactant include, but are not limited to, perfluoroalkyl phosphoric acid ester compounds, adducts of perfluoroalkyl with ethylene oxide, and polyoxyalkylene ether polymer compounds having a perfluoroalkyl ether group in its side chain. Of these, polyoxyalkylene ether polymer compounds having a perfluoroalkyl ether group in the side chain thereof are preferable because these polymer compounds do not easily foam and the fluorosurfactant represented by the following Chemical formula F-1 or Chemical formula F-2 is more preferable.

CF [symbol] CF₂(CF₂CF₂)ₘ—CH₂CH₂O(CH₂CH₂O)ₙH Chemical formula F-1

In the Chemical formula F-1, “m” is preferably 0 or an integer of from 1 to 10 and “n” is preferably 0 or an integer of from 1 to 40.

C [symbol] F [symbol] CH₂CH(OH)CH₂—O—(CH₂CH₂O)ₓ—Y Chemical formula F-2

In the compound represented by the chemical formula F-2, Y represents H or CₘF₂ₘ₊₁, where n represents an integer of from 1 to 6, or CH₂CH(OH)CH₂—CₘF₂ₘ₊1, where m represents an integer of from 4 to 6, or CₚH₂ₚ₊₁, where p is an integer of from 1 to 19. “n” represents an integer of from 1 to 6. “a” represents an integer of from 4 to 14.

The fluorochemical surfactant is commercially available on the market may be used. Specific examples include, but are not limited to, SURFLON S-111, S-112, S-113, S-121, S-131, S-132, S-141, and S-145 (all manufactured by ASAHI GLASS CO., LTD.); FLUORAD FC-93, FC-95, FC-98, FC-129, FC-135, FC-170C, FC-430, and FC-431 (all manufactured by SUMITOMO 3M); MEGAFACE F-470, F-1405, and F-474 (all manufactured by DIC CORPORATION); ZONYL TBS, FSP, FSA, FSN-100, FSN, FSO-100, FSO, FS-300, UR, and Capstone™ FS-30, FS-31, FS-3100, FS-34, and FS-35 (all manufactured by The Chemours Company); FT-110, FT-250, FT-251, FT-400S, FT-150, and FT-400SW (all manufactured by NEOS COMPANY LIMITED); POLYFOX PF-136A, PF-156A, PF-151N, PF-154, and PF-159 (manufactured by OMNOVA SOLUTIONS INC.); and UNIDYNE™ DSN-403N (manufactured by DAIKIN INDUSTRIES, Ltd.). Of these, in terms of improvement on print quality, in particular coloring property and permeability, wettability, and uniform dying property on paper, FS-3100, FS-34, and FS-300 of The Chemours Company, FT-110, FT-250, FT-251, FT-400S, FT-150, and FT-400SW of NEOS COMPANY LIMITED, POLYFOX PF-151N of OMNOVA SOLUTIONS INC., and UNIDYNE™ DSN-403N (manufactured by DAIKIN INDUSTRIES, Ltd.) are particularly preferable.

The proportion of the surfactant in the ink is not particularly limited and can be suitably selected to suit to a particular application. For example, the proportion is preferably from 0.001 to 5 percent by mass and more preferably from 0.05 to 5 percent by mass in terms of excellent wettability and discharging stability and improvement on image quality.

Defoaming Agent

The defoaming agent has no particular limit and examples thereof include, but are not limited to silicon-based defoaming agents, polyether-based defoaming agents, and aliphatic acid ester-based defoaming agents. These can be used alone or in combination. Of these, silicone-based defoaming agents are preferable in terms of the effect of breaking foams.

Preservatives and Fungicides

The preservatives and fungicides are not particularly limited. A specific example is 1,2-benzisothiazoline-3-one.

Corrosion Inhibitor

The corrosion inhibitor has no particular limitation. Examples are acid sulfites and sodium thiosulfates.

pH Regulator

The pH regulator has no particular limit as long as it can control pH to be not lower than 7. Specific examples include, but are not limited to, amines such as diethanol amine and triethanol amine.

Property of Ink

Properties of the ink are not particularly limited and can be suitably selected to suit to a particular application. For example, viscosity, surface tension, and pH are preferably in the following ranges.

Viscosity of the ink at 25 degrees C. is preferably from 5 to 30 mPa·s and more preferably from 5 to 25 mPa·s because print density and text quality improve and good dischargeability is demonstrated. Viscosity can be measured by, for example, a rotatory viscometer (RE-80L, manufactured by TOKI SANGYO CO LTD.). The measuring conditions are as follows:
Standard cone rotor (1°34′×R24)
Sample liquid amount: 1.2 mL
Number of rotations: 50 rotations per minute (rpm)
25 degrees C.
Measuring time: three minutes.

The surface tension of the ink is preferably 35 mN/m or less and more preferably 32 mN/m or less at 25 degrees C. because the ink suitably levels on a recording medium and the drying time of the ink is shortened.

pH of the ink is preferably from 7 to 12 and more preferably from 8 to 11 in terms of prevention of corrosion of metal material in contact with liquid.

The particle diameter of the solid portion in the ink has no particular limit and can be selected to suit to a particular application. The maximum frequency of the particle diameter of the solid portion in the ink is preferably from 20 to 1,000 nm and more preferably from 20 to 150 nm in the maximum number conversion to enhance discharging stability and image quality such as image density. The solid portion includes resin particles and pigments. The particle diameter can be measured by using a particle size analyzer (Nanotrac Wave-UT151, manufactured by MicrotracBEL Corp).

Recording Medium

There is no specific limitation to the recording medium and it can be suitably selected to suit to a particular application. For example, plain paper, gloss paper, special paper, cloth, film, transparent sheets, print sheet for general purpose, etc. are suitable.

In particular, the recording medium suitable for the present embodiment includes a substrate, a coated layer provided on at least one surface of the substrate, and other optional other layers.

The recording medium including the substrate and the coated layer preferably has a transfer amount of pure water to the recording medium is preferably from 2 to 35 mL/m² during a contact time of 100 ms as measured at 25 degrees C. by a liquid dynamic absorption tester. The transfer amount of pure water to the recording medium is preferably from 3 to 40 mL/m² at 25 degrees C. during a contact time of 400 m as measured by a liquid dynamic absorption tester. The recording medium having a transfer amount of pure water to the recording medium in this range at a contact time of from 100 to 400 ms includes a low permeable recording medium such as coated paper having low ink absorbency. Such a recording medium is readily frictioned in comparison with other types of recording media. Application of the ink of the present embodiment is thus particularly meaningful to such a recording medium. The transfer amount of pure water to the recording medium during a contact time of 100 ms and 400 ms can be measured for the surface having a coated layer.

The dynamic scanning absorptometer (KUGA, Shigenori, Dynamic scanning absorptometer (DSA); Journal of JAPAN TAPPI, published in May 1994, Vol. 48, pp. 88-92) can accurately measure the liquid amount absorbed in an extremely small period of time. This dynamic scanning absorptometer automates the measuring utilizing the method of directly reading the absorption speed of liquid from moving of meniscus in a capillary, spirally scanning an imbibition head on a sample having a disc-like form, and measuring the required number of points on the single sample while automatically changing the scanning speed according to predetermined patterns.

The liquid supply head supplying liquid for a paper sample is connected with the capillary via a TEFLON® tube and the position of the meniscus in the capillary is automatically read by an optical sensor.

Specifically, the transfer amount of pure water or ink can be measured using a dynamic scanning absorptometer (K350 Series D type, manufactured by Kyowa Seiko Inc.).

Each of the transfer amount during the contact time of 100 ms and 400 ms can be obtained by interpolation from the measuring results of the transfer amount in the proximity contact time of the contact time.

Substrate

There is no specific limitation to the selection of the substrate and it can be suitably selected to suit to a particular application. For example, paper mainly formed of wood fiber and a sheet material such as non-woven cloth mainly formed of wood fiber and synthetic fiber are usable.

There is no specific limit to the thickness of the substrate. The layer thickness thereof can be determined and preferably ranges from 50 to 300 μm. The weight of the substrate is preferably from 45 to 290 g/m².

Coated Layer

The coated layer contains a pigment, a binder, and other optional components such as a surfactant.

As the pigments, inorganic pigments or a combination of inorganic pigments and organic pigments can be used. Specific examples of the inorganic pigments include, but are not limited to, kaolin, talc, heavy calcium carbonate, light calcium carbonate, calcium sulfite, amorphous silica, titanium white, magnesium carbonate, titanium dioxide, aluminum hydroxide, calcium hydroxide, magnesium hydroxide, zinc hydroxide, and chlorite. The addition amount of the inorganic pigment is preferably 50 parts by mass or more based on 100 parts by mass of the binder.

Specific examples of the organic pigments include, but are not limited to, water-soluble dispersions of styrene-acrylic copolymer particles, styrene-butadien copolymer particles, polystyrene particles, and polyethylene particles. The addition amount of the organic pigment is preferably from 2 to 20 parts by mass based on 100 parts by mass of all the pigments in the surface layer.

As the binder resin, aqueous resins are preferable. As the aqueous resins, at least one of water-soluble resins and water-dispersible resins are preferable. The water-soluble resin is not particularly limited and can be suitably selected to suit to a particular application. Examples thereof include polyvinyl alcohol, cation-modified polyvinyl alcohol, acetal-modified polyvinyl alcohol, polyester, and polyurethane.

The surfactant optionally contained in the coated layer is not particularly limited and can be suitably selected to suit to a particular application. Anionic active agents, cationic active agents, amphoteric active agents, and non-ionic active agent can be used.

The method of forming the coated layer is not particularly limited and can be suitably selected to suit to a particular application. For example, methods are utilized in which liquid forming the coated layer on a substrate is applied to the substrate or a substrate is immersed in the liquid constituting the surface layer. The attachment amount of the liquid forming the coated layer is not particularly limited and can be suitably selected to suit to a particular application. The attachment amount of the solid portion preferably ranges from 0.5 to 20 g/m² and more preferably from 1 to 15 g/m².

Recorded Matter

The recorded matter has a recording medium and a print layer formed with the ink of the present embodiment on the recording medium. Because the print layer is formed by applying and drying the ink of the present embodiment, it is preferable to contain the urethane resin and styrene acrylic resin mentioned above.

Ink Accommodating Container

The ink accommodating container includes an ink accommodating unit that contains the ink of the present embodiment and other optional suitably-selected members.

The ink accommodating container is not particularly limited. Any form, any structure, any size, and any material can be suitably selected to a particular application. A container having an ink accommodating unit made of aluminum laminate film, a resin film, an ink cartridge, a large ink tank, or other containers are suitable.

Recording Method

The recording method includes applying ink and preferably other optional steps such as drying the applied ink. It is preferable that the ink be applied to a recording medium.

Ink Application

Specific examples of the method of applying the ink include, but are not limited to, inkjet methods, blade coating methods, gravure coating methods, bar coating methods, roll coating methods, dip coating methods, curtain coating methods, slide coating methods, die coating methods, and spray coating methods. Of these, the inkjet method is preferable.

Drying

The step of drying applied ink includes directly blowing heated wind to the surface of a recording medium to which the ink has been applied with an air heater or applying heat to the opposite surface of a recording medium to which the ink has been applied with a heater. It is preferable that the air heater blow 100 to 140 degrees C. wind at 20 m/minute and the heater apply heat of from 100 to 140 degrees C. It is more preferable to provide both an air heater and a heater at the same time.

Recording Device

The ink of the present embodiment can be suitably applied to various recording devices employing an inkjet recording method, such as printers, facsimile machines, photocopiers, multifunction peripherals (serving as a printer, a facsimile machine, and a photocopier), and solid freeform fabrication devices such as 3D printers and additive manufacturing devices. The recording device is capable of discharging ink or various processing fluids such as pre-processing fluid to a recording medium.

The recording device may further optionally include a device relating to feeding, conveying, and ejecting a recording medium and other devices such as a pre-processing device and a post-processing device in addition to the head portion that discharges the ink as an example of ink applying device.

The recording device may include a heating device and/or a drying device. For example, the heating device and the drying device heat and dry the print surface and the opposite surface of a recording medium. The heating device and the drying device are not particularly limited. For example, a fan heater and an infra-red heater can be used. It is possible to heat and dry a recording medium before, during, and after printing.

In addition, the recording device is not limited to those producing meaningful visible images such as text and figures with ink. For example, the recording method and the recording device capable of producing patterns like geometric design and 3D images are included.

In addition, the recording device includes both a serial type device in which the liquid discharging head is caused to move and a line type device in which the liquid discharging head is not moved, unless otherwise specified.

Furthermore, in addition to the desktop type, this recording device includes a device capable of printing images on a wide recording medium such as A0 and a continuous printer capable of using continuous paper rolled up in a roll form as recording media.

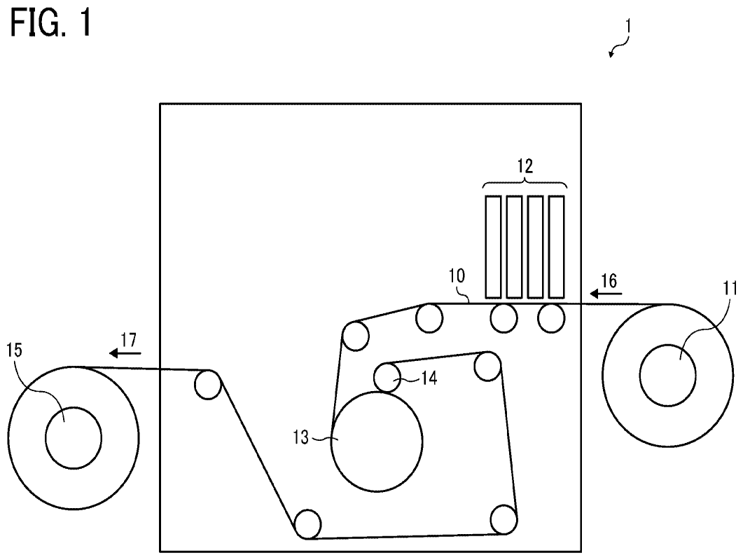

The recording device is described using an example with reference to FIG. 1. FIG. 1 is a schematic diagram illustrating an example of the recording device. A recording device 1 applies ink to a recording medium to form an image thereon. The recording device 1 includes a sheet feeder 11, a device 12 for applying ink, a drying device 13, a device 14 for applying heat and pressure, and a reeling device 15. The recording medium 10 is set in a roll form in the sheet feeder 11.

The reeling device 15 reels the recording medium 10 fed by the sheet feeder 11 in the conveyance direction indicated by arrows 16 and 17 in FIG. 1. The device 12 is a head unit constituted of inkjet line heads employing a single pass method which applies ink to the recording medium 10 fed from the sheet feeder 11 in the direction indicated by the arrow 16 to form images thereon. The drying device 13 is a heat drum that contacts and heats the surface of the recording medium 10 to which the ink is not applied. The heating temperature is set to be from 100 to 140 degrees C. The device 14 applies heat and pressure to the recording medium 10 by contacting the image on the recording medium 10 formed by applying the ink. The applied pressure is set to be, for example, from 0.005 to 0.015 kgf/cm². The temperature is set to be, for example, from 100 to 140 degrees C.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but is not limited thereto.

Preparation of Pigment Dispersion

A total of 100 g of carbon black (SEAST SP, SRF-LS, manufactured by TOKAI CARBON CO., LTD.) was added to 3,000 mL of sodium hypochlorite at 2.5 g/L followed by stirring at 300 rpm at 60 degrees C. to allow reaction for 10 hours for oxidization. As a result, a pigment in which a carboxylic acid group was placed on the surface of carbon black was obtained. The reaction liquid was filtered and the thus-filtered carbon black was neutralized with sodium hydroxide solution followed by ultra-filtering.

Thereafter, the resulting substance was subject to ultra-filtering by dialysis membrane using the pigment dispersion and deionized water followed by ultrasonic dispersion so that a black pigment dispersion having 50 percent cumulative volume particle diameter (D50) of 100 nm was obtained in which the pigment solid content was condensed to 20 percent by mass.

Preparation of Urethane Resin

The following three types of urethane resin emulsions were used.
SUPERFLEX® 150 (50 percent cumulative volume particle diameter (D50) of 30 nm, glass transition temperature Tg of 40 degrees C., manufactured by DKS Co. Ltd.)
SUPERFLEX® 150HS (50 percent cumulative volume particle diameter (D50) of 80 nm, glass transition temperature Tg of 32 degrees C., manufactured by DKS Co. Ltd.)
TAKELAC™ W-6110 (50 percent cumulative volume particle diameter (D50) of 30 nm, glass transition temperature Tg of −10 degrees C., manufactured by Mitsui Chemicals, Inc.)

Preparation of Styrene Acrylic Resin

The following three types of styrene acrylic resin emulsions were used.
Mowinyl 5450 (50 percent cumulative volume particle diameter (D50) of 50 nm, glass transition temperature Tg of 80 degrees C., manufactured by The Nippon Synthetic Chemical Industry Co., Ltd.)
Mowinyl 6600 (50 percent cumulative volume particle diameter (D50) of 140 nm, glass transition temperature Tg of 103 degrees C., manufactured by The Nippon Synthetic Chemical Industry Co., Ltd.)
Mowinyl 6969 (50 percent cumulative volume particle diameter (D50) of 100 nm, glass transition temperature Tg of 71 degrees C., manufactured by The Nippon Synthetic Chemical Industry Co., Ltd.)

Preparation of Ink

### Examples 1 to 4 and Comparative Examples 1 to 8

The mixtures formulated shown in Table 1 were stirred followed by filtering with 0.5 μm polypropylene filter to obtain inks of Examples 1 to 4 and Comparative Examples 1 to 8. The values shown in Table 1 are represented in percent by mass. Each value of the amount added relating to the pigment dispersion, urethane resin, and styrene acrylic resin shown in Table 1 is represented in solid content.

The product names and manufacturing companies of the ingredients shown in Table 1 are as follows:
Fluorochemical surfactant: FS-300, manufactured by E.I. du Pont de Nemours and Company
Preservatives and fungicides (PROXEL LV, available from Lonza Japan Ltd.)

Measuring of Breaking Stress

Dry films were prepared using the inks of Examples 1 to 4 and Comparative Examples 1 to 8 and breaking stress of the dry films was measured at 23.5 degrees C. The dry film for breaking stress measuring was prepared by placing 8.0 g of ink in a Teflon® petri dish, placing it still in a thermostatic chamber at 40 degrees C. for 12 hours followed by drying the ink in the chamber at 120 degrees C. for four hours, and cutting the dried matter into a size of 10 mm×5 mm. Breaking stress was measured according to the following conditions. The results are shown in Table 1.

### Measuring Conditions

Measuring device: Desktop precision universal tester (Autograph AGS-5kNX, manufactured by Shimadzu Corporation)
Test mode: Single
Test type: Tensile
Load cell capacity: 50 N
Control operation: Load
Control: stroke
Test speed: 50 mm/minute
Test piece form: flat plate-like form
Number of batches: 1
Number of sub-batches: 1

Evaluation on Friction Resistance in Region in Intermediate Gray Scale

Friction resistance or image defects in a region represented in intermediate gray scale was evaluated using the inks prepared in Examples 1 to 4 and Comparative Examples 1 to 8 when printed by gray scale printing.

The images were printed on a recording medium of Lumi Art Gross 130 g/m² (coated paper, manufactured by Stora Enso AB) with the inks using an inkjet printer illustrated in FIG. 1. The heating temperature by the drying device 13 of the inkjet printer was 100 degrees C., the heating temperature and pressure applied by the device 14 were respectively 100 degrees C. and 0.010 kgf/cm², and the conveyance speed of the recording medium was 0.8 m/s. In addition, gray scale printing was employed for printing with the inks. The ratio of ink dot area in the printing area was set to 75 percent.

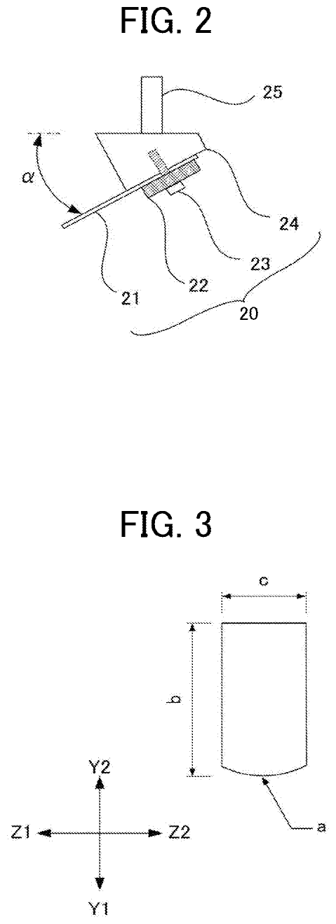

A special jig was made contact with the dried surface to which the ink had been applied to evaluate friction resistance of the image represented in intermediate gray scale. The special jig for evaluating friction resistance was described with reference to FIGS. 2 and 3. FIG. 2 is a schematic diagram illustrating an example of the jig for evaluating friction resistance. FIG. 3 is a schematic diagram illustrating an example of the plate constituting the jig for evaluating friction resistance.

As illustrated in FIG. 2, a jig 20 for evaluating friction resistance includes a plate 21, a mounting mechanism 24 having a fixed member 25 to be fixed onto a parallel conveying device, and a fixing plate 22 and a screw 23 for fixing that fix the plate 21 onto the mounting mechanism 24. The contact angle a between the plate 21 and a recording medium was adjusted to 23 degrees.

As illustrated in FIG. 3, the plate 21 has a length b of 25 mm along the Y1-Y2 direction, a width c of 15 mm on the Y2 side along the Z1-Z2 direction, and a curved portion having a radius of 150 mm on the Y1 side along the Z1-Z2 direction. The thickness of the plate 21 was 0.5 mm. The material of the plate 21 was SUS420 J2.

The jig was mounted to a variable load friction and wear tester (HHS2000, manufactured by SHINTO Scientific Co., Ltd.) for evaluating at a constant conveyance speed and load to evaluate image defects at a conveyance speed of 1.0 m/s and a load of 300 g.

The image defects was evaluated according to the following evaluation criteria. The results are shown in Table 1. B and above in the following evaluation criteria were determined as practically preferable.

### Evaluation Criteria

A: No image defects in trace of jig

B: Trace of jig blackened (ink forming image in intermediate gray scale region extends to non-imaged portion and the portion subjected to friction and wear testing look blacker than the portion not subjected to friction and wear testing)

C: Trace of jig whitened (ink forming image in intermediate gray scale region is peeled and the color (white) of recording medium exposed)

TABLE 1

| | | Example | | | |
|---|---|---|---|---|---|
| | | 1 | 2 | 3 | 4 |
| Organic solvent | 1,3-butane diol | 10.0 | 10.0 | 8.0 | 12.0 |
| | 1,2-Propane diol | 8.0 | 7.0 | 10.0 | 8.0 |
| | 3-methyl-1,3-butane diol | 10.0 | 10.0 | 10.0 | 15.0 |
| Pigment dispersion | Carbon black | 7.0 | 6.0 | 5.0 | 6.0 |
| Fluorochemical | FS-300 | 0.01 | 0.01 | 0.01 | 0.01 |
| surfactant | | | | | |
| Preservative | PROXEL LV | 0.01 | 0.01 | 0.01 | 0.01 |
| Styrene acrylic resin | Mowinyl 5450 | 6.0 | | | 4.0 |
| | Mowinyl 6600 | | 6.0 | | |
| | Mowinyl 6969D | | | 6.0 | |
| Urethane resin | TAKELAC ™ W6110 | 4.0 | 4.0 | 5.0 | 5.0 |
| | SUPERFLEX ® 150 | | | | |
| | SUPERFLEX ® 150HS | | | | |
| Water | Highly pure water | Balance | Balance | Balance | Balance |
| Total amount | | 100 | 100 | 100 | 100 |
| Breaking stress [N/mm²] | | 4.72 | 5.71 | 5.77 | 5.77 |
| Urethane resin/pigment | | 0.57 | 0.67 | 1.00 | 0.83 |
| Styrene acrylic resin/pigment | | 0.86 | 1.00 | 1.20 | 0.67 |
| Styrene-acrylic resin/urethane resin | | 1.50 | 1.50 | 1.20 | 0.80 |
| Urethane resin + styrene acrylic resin + pigment | | 17.0 | 16.0 | 16.0 | 15.0 |
| Evaluation on friction resistance in region in | | A | A | A | A |
| intermediate gray scale | | | | | |
| | | Comparative Example | | | |
| | | 1 | 2 | 3 | 4 |
| Organic solvent | 1,3-butane diol | 8.0 | 8.0 | 8.0 | 8.0 |
| | 1,2-Propane diol | 10.0 | 10.0 | 10.0 | 10.0 |
| | 3-methyl-1,3-butane diol | 10.0 | 10.0 | 10.0 | 10.0 |
| Pigment dispersion | Carbon black | 7.0 | 7.0 | 6.0 | 7.0 |
| Fluorochemical | FS-300 | 0.01 | 0.01 | 0.01 | 0.01 |
| surfactant | | | | | |
| Preservative | PROXEL LV | 0.01 | 0.01 | 0.01 | 0.01 |
| Styrene acrylic resin | Mowinyl 5450 | 7.0 | 6.0 | | 5.0 |
| | Mowinyl 6600 | | | 7.0 | |
| | Mowinyl 6969D | | | | |
| Urethane resin | TAKELAC ™ W6110 | | 2.0 | 2.0 | 3.0 |
| | SUPERFLEX ® 150 | | | | |
| | SUPERFLEX ® 150HS | | | | |
| Water | Highly pure water | Balance | Balance | Balance | Balance |
| Total amount | | 100 | 100 | 100 | 100 |
| Breaking stress [N/mm²] | | 3.52 | 4.05 | 4.10 | 4.35 |
| Urethane resin/pigment | | 0.00 | 0.29 | 0.33 | 0.43 |
| Styrene acrylic resin/pigment | | 1.00 | 0.86 | 1.17 | 0.71 |
| Styrene-acrylic resin/urethane resin | | — | 3.00 | 3.50 | 1.67 |
| Urethane resin + styrene acrylic resin + pigment | | 14.0 | 15.0 | 15.0 | 15.0 |
| Evaluation on friction resistance in region in | | C | C | C | C |
| intermediate gray scale | | | | | |
| | | Comparative Example | | | |
| | | 5 | 6 | 7 | 8 |
| Organic solvent | 1,3-butane diol | 8.0 | 8.0 | 8.0 | 8.0 |
| | 1,2-Propane diol | 10.0 | 10.0 | 10.0 | 10.0 |
| | 3-methyl-1,3-butane diol | 10.0 | 10.0 | 10.0 | 10.0 |
| Pigment dispersion | Carbon black | 5.0 | 8.0 | 6.0 | 6.0 |
| Fluorochemical | FS-300 | 0.01 | 0.01 | 0.01 | 0.01 |
| surfactant | | | | | |
| Preservative | PROXEL LV | 0.01 | 0.01 | 0.01 | 0.01 |
| Styrene acrylic resin | Mowinyl 5450 | 3.0 | 7.0 | 6.0 | 6.0 |
| | Mowinyl 6600 | | | | |
| | Mowinyl 6969D | | | | |
| Urethane resin | TAKELAC ™ W6110 | 2.0 | 3.0 | | |
| | SUPERFLEX ® 150 | | | 4.0 | |
| | SUPERFLEX ® 150HS | | | | 4.0 |
| Water | Highly pure water | Balance | Balance | Balance | Balance |

| | | | | |
|---|---|---|---|---|
| Total amount | 100 | 100 | 100 | 100 |
| Breaking stress [N/mm²] | 4.50 | 4.58 | 4.12 | 4.52 |
| Urethane resin/pigment | 0.40 | 0.38 | 0.67 | 0.67 |
| Styrene acrylic resin/pigment | 0.60 | 0.88 | 1.00 | 1.00 |
| Styrene-acrylic resin/urethane resin | 1.50 | 2.33 | 1.50 | 1.50 |
| Urethane resin + styrene acrylic resin + pigment | 10.0 | 18.0 | 16.0 | 16.0 |
| Evaluation on friction resistance in region in | C | C | B | B |
| intermediate gray scale | | | | |

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. An ink comprising:
a pigment;
a urethane resin; and
a styrene acrylic resin,
wherein dry film of the ink has a breaking stress of 4.7 or greater N/mm².

2. The ink according to claim 1, wherein the urethane resin has a glass transition temperature Tg of −10 or lower degrees C.

3. The ink according to claim 1, wherein a mass ratio of the urethane resin to the pigment is 0.55 or greater.

4. The ink according to claim 1, wherein the urethane resin is present in a form of a resin particle.

5. The ink according to claim 4, wherein the urethane resin has a 50 percent cumulative volume particle diameter D50 of from 10 to 30 nm.

6. The ink according to claim 1, wherein the styrene acrylic resin is present in a form of a resin particle.

7. The ink according to claim 1, wherein the urethane resin and the styrene acrylic resin are present in a form a resin particle and a 50 percent cumulative volume particle diameter D50 of the urethane resin is smaller than a 50 percent cumulative volume particle diameter D50 of the styrene acrylic resin.

8. An ink accommodating container, comprising:
a container; and
the ink of claim 1 contained in the container.

9. A recording device comprising:
a recording medium;
the ink accommodating container of claim 8; and
an ink applying device configured to apply the ink in the ink accommodating container to the recording medium.

10. The recording device according to claim 9, wherein the recording medium includes a substrate and a coated layer on at least one side of the substrate,
wherein transfer amounts of pure water to the coated layer in a contact time of 100 ms and 400 ms are respectively 2 to 35 mL/m² and 3 to 40 mL/m² as measured with a dynamic scanning absorptometer at 25 degrees C.

11. The recording device according to claim 9, wherein a conveyance speed of the recording medium is 0.8 or greater m/s.

12. A recording method comprising:
applying the ink of claim 1 to a recording medium.
